(19) United States
(12) Patent Application Publication
(10) Pub. No.: US 2020/0013060 A1
(43) Pub. Date: Jan. 9, 2020

(54) FILTERING AUTHORIZATIONS

(71) Applicant: Syntegrity Networks Inc., Seattle, WA (US)

(72) Inventor: Nathanael Coffing, Seattle, WA (US)

(21) Appl. No.: 16/459,375

(22) Filed: Jul. 1, 2019

Related U.S. Application Data
(60) Provisional application No. 62/692,383, filed on Jun. 29, 2018.

(51) Int. Cl. G06Q 20/40; H04L 29/06; G06Q 20/38

(52) U.S. Cl. CPC G06Q 20/405; G06Q 20/3825; H04L 63/0245

(57) ABSTRACT

Systems and methods for filtered authorizations for transactions are provided. Information may be stored in memory regarding a plurality of authorization rules, each of which may be specific to one or more transaction parameters. A transaction request sent by a requesting user via a cloud-native application may be received at a remote location. The transaction request may be broken down into one or more transaction segments, each of which may be associated with a respective location. A set of authorization rules may be identified as being applicable to each transaction segment of the received transaction request. The set of authorization rules may be identified based on the requesting user at the remote location, the respective location, and the transaction parameters specified by the set of authorization rules. The results of each transaction segment of the received transaction request may be filtered based on the respective identified set of authorization rules. The filtered results may be provided to the requesting user.

### CROSS-REFERENCE TO RELATED APPLICATIONS

The present patent application claims the priority benefit of U.S. provisional patent application No. 62/692,383 filed Jun. 29, 2018, the disclosure of which is incorporated by reference herein.

### BACKGROUND OF THE INVENTION

### 1. Field of the Invention

The present invention generally relates to cloud-native applications. More specifically, the present invention relates to managing and filtering authorizations for cloud-native applications.

### 2. Description of the Related Art

Before the advent of cloud-native applications, centralized application infrastructures could be architected with hard perimeters. For example, separate data stores could be provided for different locations to allow for application of jurisdiction-specific policies and rules. Distributed environments—such as the case of cloud-native applications—lack such hard perimeters, however.

Following the enactment of the General Data Protection Regulation (GDPR) in the European Union, for example, personal data regarding citizens and residents are subject to certain controls governing storage, processing, distribution, and export. A transaction request that involves such data may be handled by prior art systems that allocate separate data stores for each different location subject to the different controls. Such a solution may not be practical, however, where the same stream may be implicate multiple different regulatory schemes. Further jurisdictions are enacting their own sets of statues, rules, and regulations regarding privacy and other types of data controls. Such disparate treatment and regulatory schemes complicate the problem of how to handle data requests.

There is, therefore, a need in the art for systems and methods of filtering authorization for cloud-native applications.

### SUMMARY OF THE CLAIMED INVENTION

Embodiments of the present invention provide cloud-native applications (inclusive of cloud-based services or workloads) with filtered authorizations based on end-user parameters. In such embodiments, cloud-native applications may be provided with a respective identity in cloud environments. Data provided via such cloud-native applications may be subject to a new paradigm for filtered authorization. Filtered authorization may be based on predetermined authorization rules governing adaptation to the changing location, security requirements, and risk tolerance involved in each transaction. As a result of such filtering, only certain pieces of data with comply with the applicable rules will be provided in response to the requested transaction.

Various embodiments may include methods for filtered authorizations for transactions. Such methods may include storing information regarding a plurality of authorization rules each specific to one or more transaction parameters, receiving a transaction request sent by a requesting user at a remote location via a cloud-native application, breaking down the transaction request into one or more transaction segments each associated with a respective location, and identifying a set of authorization rules that are applicable to each transaction segment of the received transaction request based on the requesting user at the remote location, the respective location, and the transaction parameters specified by the set of authorization rules. Methods may further include filtering results of each transaction segment of the received transaction request based on the respective identified set of authorization rules, and providing the filtered results to the requesting user.

Further embodiments include systems for filtered authorizations for transactions. Such systems may include memory that stores information regarding a plurality of authorization rules each specific to one or more transaction parameters, a communication interface that receives a transaction request sent by a requesting user at a remote location via a cloud-native application, and a processor that executes instructions to break down the transaction request into one or more transaction segments each associated with a respective location, to identify a set of authorization rules that are applicable to each transaction segment of the received transaction request based on the requesting user at the remote location, the respective location, and the transaction parameters specified by the set of authorization rules, and to filter results of each transaction segment of the received transaction request based on the respective identified set of authorization rules. The communication interface may further provide the filtered results to the requesting user.

Yet further embodiments may include non-transitory computer-readable storage media having embodied thereon programs that are executable to perform the methods described herein.

### BRIEF DESCRIPTION OF THE FIGURES

FIG. 1 illustrates a simplified network environment in which a system for filtering authorizations may be implemented.

FIG. 2 is a flowchart illustrating an exemplary method for filtering authorizations.

FIG. 3 illustrates an exemplary computing system that may be used to implement an embodiment of the present invention.

### DETAILED DESCRIPTION

Embodiments of the present invention provide cloud-native applications (inclusive of cloud-based services or workloads) with filtered authorizations based on end-user parameters. In such embodiments, cloud-native applications may be provided with a respective identity in cloud environments. Data provided via such cloud-native applications may be subject to a new paradigm for filtered authorization. Filtered authorization may be based on predetermined authorization rules governing adaptation to the changing location, security requirements, and risk tolerance involved in each transaction. As a result of such filtering, only certain pieces of data with comply with the applicable rules will be provided in response to the requested transaction.

For example, following the enactment of the General Data Protection Regulation (GDPR) in the European Union, personal data regarding citizens and residents are subject to certain controls governing storage, processing, distribution, and export. In contrast to prior art systems, filtered authorization allows administrators to specify data allowed to be provided to different transaction workloads based on attributes of the transaction request (e.g., location of the requesting user). As such, a transaction may involve a first workload performed in the UK, the results of which may be provided to a second workload in Germany to provide a final result. Such data may be filtered with respect to GDPR-compliant policies before being exposed to the requestor.

Such filtering may involve receiving the transaction request via a cloud-native application. Such transaction request may be initiated by a requesting user and may include relevant details (e.g., location of requesting user) that may serve as the basis for authorization filtering. The transaction request may further be broken down into multiple workloads, each of which may be associated with its own specific rules. Such segmentation of the transaction may be based on who the requesting user is and his or her location. Each segment may therefore provide a certain result, the data of which may be filtered based on the authorization rules and policies before being exposed to the requesting user. Filtered authorizations therefore act as a gatekeeper to common data stores, which avoid redundancy, increases efficiency, and provides for more flexibility and workload balancing in dealing with a variety of transactions originating from different locations.

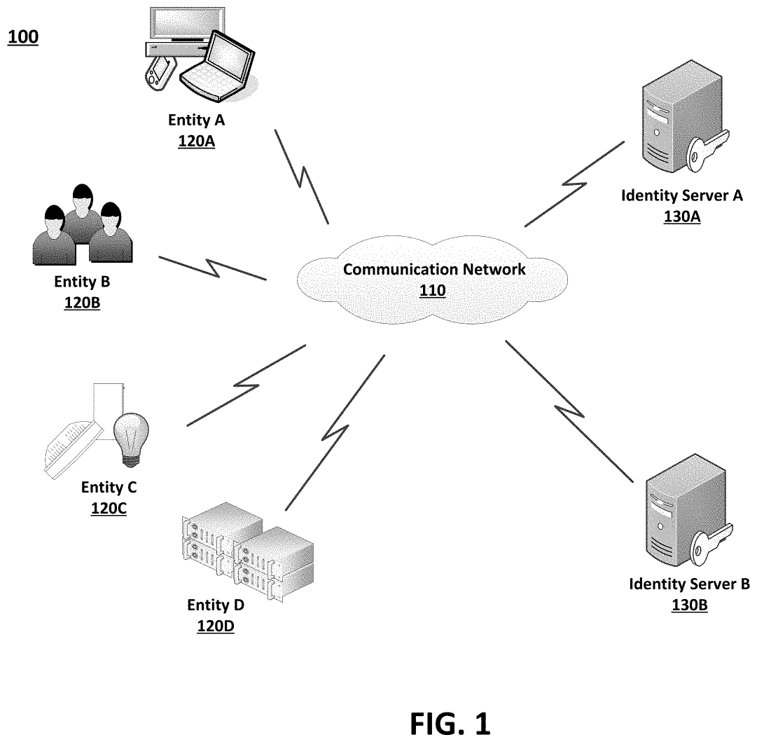

FIG. 1 illustrates a simplified network environment in which a system for filtering authorizations may be implemented. As illustrated, an exemplary network environment 100 may include a variety of different entities, including entity A 120A (e.g., personal user devices), entity B 120B (e.g., individual users), entity C 120C (e.g., Internet of Things (IoT) devices), and entity D 120D (e.g., services/server systems), each at a respective location. Such entities 120A-D may communicate over one or more different types of communication networks 110 with one or more identity servers A 130A and B 130B.

Communication network 110 may include a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, cellular or mobile service providers, a cable service provider, a provider of digital subscriber line (DSL) services, or a satellite service provider. Communications network 110 allows for communication between the various components of network environment 100.

In some instances, entities 120A-D may communicate with identity servers 130 over communication network 110 via an API gateway (not pictured) associated with a cloud-native application. Such an API gateway may serve as an entry point for an entity 120 to a service mesh. API gateway may expose public endpoints for identification and authentication, as well as inject into a data stream contextual data (e.g., via a token to proxied requests signed using a private key issued exclusively for the API gateway (e.g., by an internal certificate authority in a security plane)). API gateway can enforce rich policies that can be created in identity server 130 (e.g., based on such factors as user attributes, roles, relationships, session attributes, current location, device information, authentication methods used, and risk factor of a transaction user or a device) Entities 120A-D may use or be embodied in any number of different electronic devices, such as general purpose computers, mobile phones, smartphones, smartwatches, wearable devices, personal digital assistants (PDAs), portable computing devices (e.g., laptop, netbook, tablets), desktop computing devices, handheld computing device, smart sensors, smart appliances, IoT devices, devices networked to controllers for smart control, servers and server systems (including cloud-based servers and server systems), or any other type of computing device capable of communicating over communication network 110. Such devices associated with entities 120A-D may also be configured to access data from other storage media, such as local caches, memory cards, or disk drives as may be appropriate in the case of downloaded services. Devices associated with entities 120-A-D may include standard hardware computing components such as network and media interfaces, non-transitory computer-readable storage (memory), and processors for executing instructions that may be stored in memory.

Identity servers 130 may provide a platform for managing data stream identity. Identity server 130 may be installable in the cloud or on-premises. Such identity server 130 may also include a public key infrastructure (PKI) that allows for reading, generation, assignment, and management of digital certificates, security keys, and other encryption data. Identity server 130 may therefore uniquely associate each entity 120 with a set of identification data that allows for entity-specific identification, digital signature, and/or encryption. Entity-specific identity information may be generated by one or more identity servers 130, as well as other identity providers (e.g., Facebook, OAuth OpenID, biometric signatures).

Identity servers 130 may be responsible for processing data requests and filtering the results of such requests in accordance with the applicable rules and regulations. Identity servers 130 may therefore receive a transaction request via a cloud-native application, which may have been initiated by a requesting user and which may indicate information such as the location of requesting user. Identity servers 130 may thereafter break the transaction request down into multiple workloads, each of which may be associated with its own specific rules.

Such segmentation of the transaction may be based on who the requesting entity is and its respective location. Each segment may therefore provide a certain result, the data of which may be filtered based on the authorization rules and policies before being exposed to the requesting user. Filtered authorizations therefore act as a gatekeeper to common data stores, which avoid redundancy, increases efficiency, and provides for more flexibility and workload balancing in dealing with a variety of transactions originating from different locations.

In addition to filtering, identity servers 130 may further have the ability to sample from data streams so as to identify at each step in a transaction specifically what data may be released to a requesting entity. Each entity involved in a transaction may be identified based on a digital signature that may be associated with or packaged in the data stream. In some instances, a transaction may involve one entity requesting or subscribing to personally identifying information (PII) elements from or regarding another entity. Identity servers 130 may sample a data stream by evaluating such parameters as specification of the request (e.g., requested service), ingress API of receiving entity, and sampling data being pushed out. Such sampling allows identity servers 130 to know what data is being released, as well as to obtain insights into the contents of the data stream.

Identity servers 130 may also aggregate different authorization policies into a package of control policies. Such packaged policies allow for fine-grained control by each entity over its associated data. For example, the image of a particular entity may be captured in a video at an identified location. A different entity at a different location may request access to such video. Identity server 130 may determine that the video stream contains images of the captured entity, identify the applicable package of control policies, and specifically apply the identified package of control policies to the request. If authorized under such control policies, the requesting entity may be provided with access to at least the segments of video that include the captured entity. Such a process may be performed by identity server 130 for each entity captured in the video. Identity servers 130 may therefore provide entities with an identity, allow for fine-grained policies for each identity, verify and use identity of requesting for authorizations and permissions, monitor and audit data usage, and provide entities tools to manage and control their digital footprint.

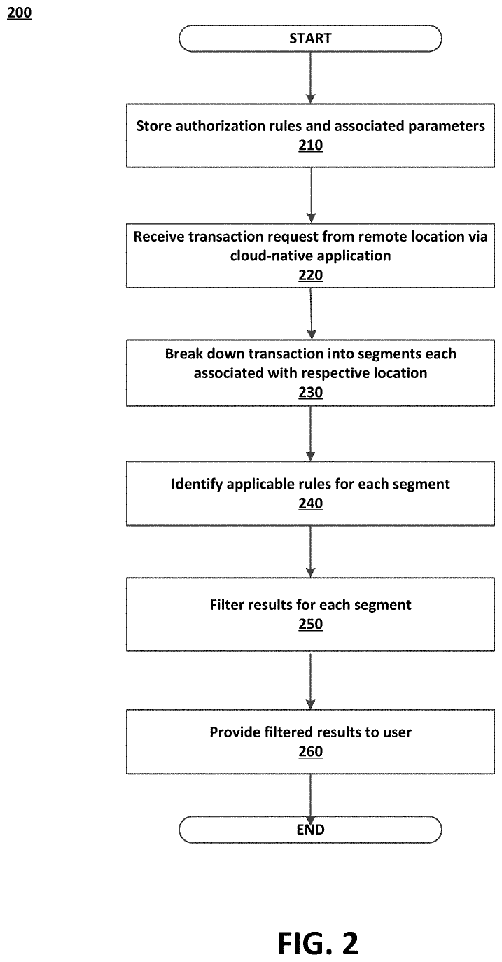

FIG. 2 is a flowchart illustrating an exemplary method for filtering authorizations. The method 200 of FIG. 2 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 2 (and the order thereof) are exemplary and may include various alternatives, equivalents, or derivations thereof including but not limited to the order of execution of the same.

In step 210, authorization rules and associated parameters may be stored in memory. Such rules may be associated with specific one or more entities involved, respective locations of each entity, and respective location of a transaction or segment thereof. Parameters may specify the conditions under which access is to be granted or denied. Such parameters may be specified by the specific entity identified as an owner, as well as by legal and regulatory schemes that are applicable to the geographic location.

In step 220, a transaction request may be sent by a requesting entity 120 at a remote location via a cloud-native application and received by identity server 130. Data associated with the transaction request may indicate an identity of the requesting entity 120, as well as its geographic location.

In step 230, the identity server 130 may analyze the transaction request. Such analysis may include breaking down the transaction request into multiple segments based on association with different locations. For example, one segment may be associated with one location, while another segment may be associated with a different location.

In step 240, the identity server 130 may identify a set of rules that are applicable to each segment. Such rules may be identified from those stored in memory in step 210. In addition, identifying the applicable set of rules may further be based on the requesting entity and its location, the location of the respective segment, and the transaction parameters specified by the rules.

In step 250, identity server 130 may filter the results of each transaction segment based on the respective set of applicable rules. As such, different sets of data within the transaction may be subject to different sets of rules, which allows for fine-grained control of data in compliance with multiple different applicable rules. Finally, in step 260, the filtered results are provided to the requesting entity 120 over the communication network 110.

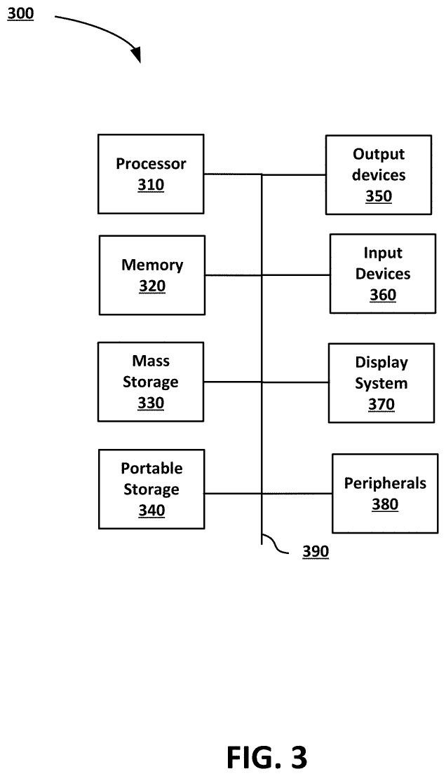

FIG. 3 illustrates an exemplary computing system 300 that may be used to implement an embodiment of the present invention. System 300 of FIG. 3 may be implemented in the contexts of the likes of entity A devices 120A, entity C 120C, or entity D 120D, as well as those used by used by entity B 120B. The computing system 300 of FIG. 3 includes one or more processors 310 and memory 310. Main memory 310 stores, in part, instructions and data for execution by processor 310. Main memory 310 can store the executable code when in operation. The system 300 of FIG. 3 further includes a mass storage device 330, portable storage medium drive(s) 340, output devices 350, user input devices 360, a graphics display 370, and peripheral devices 380.

The components shown in FIG. 3 are depicted as being connected via a single bus 390. However, the components may be connected through one or more data transport means. For example, processor unit 310 and main memory 310 may be connected via a local microprocessor bus 390, and the mass storage device 330, peripheral device(s) 380, portable storage device 340, and display system 370 may be connected via one or more input/output (I/O) buses 390.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 310.

Portable storage device 340 operates in conjunction with a portable non-volatile storage medium, such as a floppy disk, compact disk (CD) or digital video disc (DVD), to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 receives textual and graphical information, and processes the information for output to the display device.

Peripherals 380 may include any type of computer support device to add additional functionality to the computer system. For example, peripheral device(s) 380 may include a modem or a router.

The components contained in the computer system 300 of FIG. 3 are those typically found in computer systems that may be suitable for use with embodiments of the present invention and are intended to represent a broad category of such computer components that are well known in the art. Thus, the computer system 300 of FIG. 3 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus (e.g., bus 390) carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for filtered authorizations for transactions, the method comprising:
storing information regarding a plurality of authorization rules, each rule specific to one or more transaction parameters;
receiving a transaction request sent by a requesting user at a remote location, the transaction request sent via a cloud-native application;
breaking down the transaction request into one or more transaction segments, wherein each transaction segment is associated with a respective location;
identifying a set of authorization rules that are applicable to each transaction segment of the received transaction request, wherein the set of authorization rules is identified based on the transaction parameters specified by the set of authorization rules;
filtering results of each transaction segment of the received transaction request based on the respective identified set of authorization rules; and
providing the filtered results to the requesting user.

2. The method of claim 1, wherein the set of authorization rules is identified further based on the requesting user at the remote location.

3. The method of claim 1, wherein the set of authorization rules is identified further based on the respective location of the respective segment.

4. The method of claim 1, further comprising sampling at least one of the transaction segments.

5. The method of claim 1, further comprising identifying the requesting user based on a digital signature associated with the transaction request.

6. The method of claim 1, wherein the transaction request includes a subscription to personally identifying information (PII).

7. The method of claim 1, further comprising aggregating the set of authorization rules into a package associated with the transaction.

8. The method of claim 1, wherein each of the transaction segments is associated with a different set of PII.

9. The method of claim 1, further comprising auditing each transaction segment for compliance to the respective set of applicable rules.

10. A system for filtered authorizations for transactions, the system comprising:
memory that stores information regarding a plurality of authorization rules, each rule specific to one or more transaction parameters;
a communication interface that receives a transaction request sent by a requesting user at a remote location, the transaction request sent via a cloud-native application; and
a processor that executes instructions stored in memory, wherein execution of the instructions by the processor:
breaks down the transaction request into one or more transaction segments, wherein each transaction segment is associated with a respective location,
identifies a set of authorization rules that are applicable to each transaction segment of the received transaction request, wherein the set of authorization rules is identified based on the transaction parameters specified by the set of authorization rules, and
filters results of each transaction segment of the received transaction request based on the respective identified set of authorization rules;
wherein the communication interface provides the filtered results to the requesting user.

11. The system of claim 10, wherein the processor identifies the set of authorization rules further based on the requesting user at the remote location.

12. The system of claim 10, wherein the processor identifies the set of authorization rules further based on the respective location of the respective segment.

13. The system of claim 10, wherein the processor further samples at least one of the transaction segments.

14. The system of claim 10, wherein the processor further identifies the requesting user based on a digital signature associated with the transaction request.

15. The system of claim 10, wherein the transaction request includes a subscription to personally identifying information (PII).

16. The system of claim 10, wherein the processor further aggregates the set of authorization rules into a package associated with the transaction.

17. The system of claim 10, wherein each of the transaction segments is associated with a different set of PII.

18. The system of claim 10, wherein the processor further audits each transaction segment for compliance to the respective set of applicable rules.

19. A non-transitory computer-readable storage medium, having embodied thereon a program executable by a processor to perform a method for filtered authorizations for transactions, the method comprising:
storing information regarding a plurality of authorization rules, each rule specific to one or more transaction parameters;
receiving a transaction request sent by a requesting user at a remote location, the transaction request sent via a cloud-native application;
breaking down the transaction request into one or more transaction segments, wherein each transaction segment is associated with a respective location;
identifying a set of authorization rules that are applicable to each transaction segment of the received transaction request, wherein the set of authorization rules is identified based on the transaction parameters specified by the set of authorization rules;
filtering results of each transaction segment of the received transaction request based on the respective identified set of authorization rules; and
providing the filtered results to the requesting user.
